(19) United States
(12) Patent Application Publication
(10) Pub. No.: US 2018/0129519 A1
(43) Pub. Date: May 10, 2018

(54) METHOD AND SYSTEM FOR EMULATING APPLICATION RUNNING IN SECONDARY DEVICE ON PRIMARY DEVICE

(71) Applicant: Srinivas Bharadwaj, (US)

(72) Inventor: Srinivas Bharadwaj, Los Altos, CA (US)

(21) Appl. No.: 15/346,691

(22) Filed: Nov. 8, 2016

(51) Int. Cl. G06F 9/455; H04L 29/08; G06F 9/54; G06F 21/62; H04L 29/06; G06F 3/14

(52) U.S. Cl. CPC G06F 9/45508; H04L 67/10; G06F 9/542; G06F 3/1454; H04L 63/102; H04L 63/105; G06F 21/629

(57) ABSTRACT

Embodiments herein achieve a method for emulating an application running in a secondary device on a primary device. The method includes receiving, by the primary device, information of an event associated with the application running in the secondary device. Further, the method includes emulating, by the primary device, a graphical representation of the application running in the secondary device based on the information of the event. Furthermore, the method includes displaying, by the primary device, the graphical representation of the application running in the secondary device.

### TECHNICAL FIELD

The present disclosure relates to a cloud computing, and more particularly to a mechanism for emulating an application, running in a secondary device, on a primary device. The present application is based on, and claims priority from an U.S. application Ser. No. 62/285,818 filed on Nov. 9, 2015 the disclosure of which is hereby incorporated by reference herein.

### BACKGROUND

A plethora of devices from phones and tablets, to an Internet of Things (IoT) and wearable technologies like smart watches have substantially increased productivity of workforce. As these devices start gaining an application base, the need to integrate them into existing networks and operating systems is becoming important. Several modes of application execution are evolved to manage different applications in the networks and operating systems. In order to integrate these platforms into the networks and operating systems, several problems related to security, connectivity, session state, reconnection, or the like have to be resolved. The new wearable devices continue to emerge, so that their platforms continue to be upgraded and enhanced. Integrating these devices into a personal computing environment, and into a home environment is being actively pursued. In parallel an emerging paradigm with IoT computing and distribution is being created and developed day by day.

Integrating wearable devices into the computing environment needs to deal with both application handling and management as well as with the variety of devices and technologies that are part of the growing wearable devices ecosystem. A common framework or platform for this revolves around needing a simple set of tools to build applications as well as be able to deploy and share application across the devices and with other traditional devices and systems. The challenges have to deal with both the platform level integration into personal computing networks, home networks, wireless networks, and importantly into enterprise networks both public and private, intranets, and extranets.

Further, many users use multiple mobile computing devices to achieve their communication needs and for various tasks throughout their day. Further, the user desires to view or access an application running on another mobile computing device using various techniques. One of the techniques is a cloud computing technique, in which all of the data associated with the application relevant to the user is stored in an online storage cloud and the user can access or interact with that application via a connected computing device. Other techniques include an event simulation technique, a remote display technique, or the like.

But, the conventional systems and methods are effective to a degree in emulating the application, running in a first mobile computing device, on a second mobile computing device but includes both advantages and disadvantages in terms of memory power, loss of information due to a data storage, cost, accuracy, power, fast, an ability to support multiple environments and operating systems, establishing the communication, reliable in communication, or the like.

Thus, there remains a need of a robust system and method for emulating the application running in the first mobile computing device on the second mobile computing device.

### SUMMARY

Embodiments herein disclose a method for emulating an application, running in a secondary device, on a primary device. The method includes receiving, by the primary device, information of an event associated with the application running in the secondary device. Further, the method includes emulating, by the primary device, a graphical representation of the application running in the secondary device based on the information of the event. Furthermore, the method includes displaying, by the primary device, the graphical representation of the application running in the secondary device.

In an embodiment, the graphical representation of the application running in the secondary device is emulated on the primary device by identifying a user of the secondary device based on an identity management system and authorizing a level of access to the graphical representation of the application running in the secondary device to a user of the primary device.

In an embodiment, the identity management system is configured to store a relationship of each of the secondary device with corresponding user to dynamically determine the identity of the user of the secondary device.

In an embodiment, the identity management system is configured to dynamically update the relationship when a user of the secondary device is changed.

In an embodiment, the relationship is setup by the identity management system to deliver the information of the event associated with the application running in the secondary device to the primary device using a brokering agent.

In an embodiment, the brokering agent determines the at least one portion of the graphical representation of the application running in the at least one secondary device to be emulated on the primary device.

In an embodiment, a time unit at which the information of the event received at the primary device is different than a time unit at which the event is generated in the at least one secondary device.

In an embodiment, the information of the event is received at the primary device at a time unit different than a time unit at which the event is generated in the secondary device.

In an embodiment, a time unit at which the graphical representation of the application running in the at least secondary device displayed on the primary device is different than a time unit at which the at least one secondary device displays the graphical representation.

In an embodiment, the difference is caused due to at least one of a periodic interval and a time taken to wait for the information to be received from a series of the secondary devices.

In an embodiment, the graphical representation displays a state of the application running in the secondary device, where the state of the application is dynamically determined based on the information of the event associated with the application running in the secondary device.

In an embodiment, the time unit at which the state of the application running in the at least secondary device on the primary device is different than a time unit at which the state of application changes in the at least one secondary device.

In an embodiment, the secondary device is a wearable device.

In an embodiment, the secondary device is an Internet of Things (IoT) device.

In an embodiment, the secondary device does not comprises a display screen.

In an embodiment, the secondary device does not comprises a user interface.

In an embodiment, the secondary device does not comprises the display screen and the user interface.

In an embodiment, the application, running in the secondary device, does not comprises a user interface.

Further, embodiments herein disclose a method for emulating an application running in a secondary device on a primary device. The method includes receiving, by the primary device, information about a graphical representation on the primary device. Further, the method includes emulating, by the primary device, the graphical representation of the application running in the secondary device. Furthermore, the method includes displaying, by the primary device, the graphical representation of the application running in the secondary device. A time unit at which the graphical representation of the application running in the at least secondary device displayed on the primary device is different than a time unit at which the at least one secondary device displays the graphical representation.

In an embodiment, the graphical representation of the application running in the secondary device is emulated in the primary device by identifying a user of the secondary device based on an identity management system and authorizing an level of access to the graphical representation of the application running in the secondary device to a user of the primary device based on the identity of the user of the primary device. The information of the event associated with the application running in the primary device corresponds to the user of the secondary device.

Further, embodiments herein disclose a primary device for emulating an application running in a secondary device. The primary device includes an emulating engine configured to receive information of an event associated with the application running in the secondary device. The emulating engine is further configured to emulate a graphical representation of the application running in the secondary device based on the information of the event. The emulating engine is further configured to display the graphical representation of the application running in the secondary device.

Further, embodiments herein disclose a primary device for emulating an application running in a secondary device. The primary device includes an emulating engine configured to receive information about a graphical representation on the primary device. Further, the emulating engine is configured to emulate the graphical representation of the application running in the secondary device. Further, the emulating engine is configured to display the graphical representation of the application running in the secondary device.

Further, embodiments herein disclose a system for emulating an application running in a secondary device on a primary device. The system includes the primary device and the secondary device. The secondary device is configured to detect an event associated with the application running in the secondary device. The secondary device is itself configured to display a graphical representation of the application based on the event. The secondary device is configured to send information about the graphical representation to the primary device. Further, the primary device is configured to receive the information about the graphical representation and emulate the graphical representation of the application running in the secondary device. Further, the primary device is configured to display the graphical representation of the application running in the secondary device.

Further, embodiments herein disclose a system for emulating an application running in a secondary device on a primary device. The system includes the primary device and the secondary device. The secondary device is configured to detect information about a graphical representation. The secondary device is configured to display the graphical representation of the application. The secondary device is configured to send information about the graphical representation to the primary device. Further, the primary device is configured to receive the information about the graphical representation and emulate the graphical representation of the application running in the secondary device. Further, the primary device is configured to display the graphical representation of the application running in the secondary device.

Accordingly the embodiment herein provides a computer program product including a computer executable program code recorded on a computer readable non-transitory storage medium. The computer executable program code when executed causing the actions including receiving, by a primary device, information of an event associated with an application running in a secondary device. The computer executable program code when executed causing the actions including emulating, by the primary device, a graphical representation of the application running in the secondary device based on the information of the event. The computer executable program code when executed causing the actions including displaying, by the primary device, the graphical representation of the application running in the secondary device.

Accordingly the embodiment herein provides a computer program product including a computer executable program code recorded on a computer readable non-transitory storage medium. The computer executable program code when executed causing the actions including receiving, by a primary device, information about a graphical representation on a secondary device. The computer executable program code when executed causing the actions including emulating, by the primary device, the graphical representation of the application running in the secondary device. The computer executable program code when executed causing the actions including displaying, by the primary device, the graphical representation of the application running in the secondary device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

This invention is illustrated in the accompanying drawings, throughout which like reference letters indicate corresponding parts in the various figures. The embodiments herein will be better understood from the following description with reference to the drawings, in which:

FIG. 1a illustrates a system for emulating an application, running in a secondary device, on a primary device based on a detected event associated with the application running in the secondary device, according to embodiments as disclosed herein;

FIG. 1b illustrates a system for emulating the application, running in the secondary device, on the primary device based on a received information about a graphical representation of the secondary device, according to embodiments as disclosed herein;

FIG. 2a illustrates a system for emulating the application, running in the secondary device, on the primary device through a brokering agent based on a detected event associated with the application running in the secondary device, according to embodiments as disclosed herein;

FIG. 2b illustrates a system for emulating the application running in the secondary device on the primary device, through the brokering agent, based on the received information about the graphical representation of the secondary device, according to embodiments as disclosed herein;

FIG. 3 illustrates various units included in the secondary device, according to embodiments as disclosed herein;

FIG. 4 illustrates various units included in the primary device, according to embodiments as disclosed herein;

FIG. 5 is a sequence diagram illustrating a step by step procedure involved in emulating the application, running in the secondary device, on the primary device, according to embodiments as disclosed herein;

FIG. 6 is a flow diagram illustrating a method for emulating the application, running in the secondary device, on the primary device based on the detected event associated with the application running in the secondary device, according to embodiments as disclosed herein;

FIG. 7 is a flow diagram illustrating a method for emulating the application running in the secondary device on the primary device based on the received information about the graphical representation of the secondary device, according to embodiments as disclosed herein;

FIG. 8 is a flow diagram illustrating a method for emulating the application, running in the secondary device, on the primary device based on the identify the user of the plurality of secondary devices, according to embodiments as disclosed herein;

FIG. 9 is an example illustration in which the application running in the plurality of secondary device including a display is emulated on the primary device, according to embodiments as disclosed herein;

FIG. 10 is an example illustration in which the application running in the plurality of secondary device with or without display is emulated on the primary device, according to embodiments as disclosed herein;

FIG. 11 is an example illustration in which the application running in the plurality of secondary device is emulated on the primary device based on an access level, according to embodiments as disclosed herein;

FIG. 12 illustrates a system for emulating the application running in the secondary device on the primary device over an IoT network, according to embodiments as disclosed herein; and

FIG. 13 illustrates a computing environment implementing a mechanism for emulating the application running in the secondary device on the primary device, according to embodiments as disclosed herein.

### DETAILED DESCRIPTION OF EMBODIMENTS

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The embodiments herein provide a method for emulating an application, running in a secondary device, on a primary device. The method includes receiving, by the primary device, information of an event associated with the application running in the secondary device. Further, the method includes emulating, by the primary device, a graphical representation of the application running in the secondary device based on the information of the event. Furthermore, the method includes displaying, by the primary device, the graphical representation of the application running in the secondary device.

Unlike the conventional systems and the methods, the proposed method can be used to detect system generated events (e.g., sensor reading update or any other kind of User Interface (UI) update) without a user interaction. The proposed method can be used to detect the sensor device changes, capture all the details from the sensors devices and then transfer the details to the primary device (i.e., remote device). The primary device emulates all the information without the user interaction.

The proposed method can be used to emulate the application running in the secondary device on the primary device in a networked environment (e.g., virtualized IOT enabled networked environment, a User Our Device (UOD) environment, a Bring Your Own Device (BYOD) environment or the like) without any user interaction.

A service oriented architecture facilitates the availability of services and a federated delivery of IT services. The world of IoT and wearable devices and their applications are not just service oriented but often need an event driven architecture. The control and management of devices, sensors, and the monitoring of new sources of the remote data and events drives the new architectures that need to evolve to grow with the emergence and importance of these new platforms. The virtualization in this context is slightly different from the way traditional virtualization works. Clients and servers interact in various ways. However, masters and slaves also interact, peer-to-peer entities, originals and clones also interact as do other forms and models of communication. The IoT and wearable devices and their applications require a unique set of mechanisms for interaction.

Early interactive models like Home Audio Visual Interface (HAVi) have a range of interactions involving the control, management while allowing for an easy plug and play. The HAVi is primarily devised for the home network. The broader enterprise network and the extranet virtual networks or dedicated or virtual custom networks for the IoT and the wearable devices are provided where the devices have to operate and the network has to allow for their control, access, and event delivery.

Events like timers or asynchronous events created by serendipitous or specific events that occur, trigger, and require handling are the basis for facilitating new methods to manage and monitor the data generated and the devices themselves. For example, in an electrical utility network, the rise in power through a particular junction may lead to devices allied with that junction to connect and contact other devices with information.

The internet model of communication implies a broad front-end, back-end interaction. Browsers or applications that use a browser sandbox with a presentation, a Virtual Machine (VM) or Scripting language, connect to a front end application that builds state around the application, a view of which is reflected to the browser. The back end of such an internet system builds a model by having data collectors that gather large amounts of data and then have a view show that shows a portion of this data to the front end. A different model would provide a mix of data that involves both this traditional multi-tier model as well as a device management and control system that directly interacts with applications that run on the device or are developed for the particular device.

IoT Platforms:

Raspberry Pi and Arduino are among the popular platforms for IOT devices and they represent the beginning of a plethora of platforms, environments and devices that are likely to become important in the IOT. The platforms will all have applications that have to interface with the native event systems on the devices and with executable environments that run applications. Further, one of the commonly used platforms is LLVM. The LLVM can be used as a compiler framework, where the user provides a “front end” (parser) and the back end (code that converts) LLVM's representation to actual machine code. The LLVM has been ported to Raspberry Pi and a range of other platforms. From the LLVM manual, “The LLVM representation aims to be light-weight and low-level while being expressive, typed, and extensible at the same time. It aims to be a “universal IR” of sorts, by being at a low enough level that high-level ideas may be cleanly mapped to it (similar to how microprocessors are “universal IR's”, allowing many source languages to be mapped to them)”. While replicating events from the underlying system, a callback mechanism from the underlying platform needs to be implemented. Trampolines and exception handling mechanisms offer means to call out to outside the VM. This provides a basis for how external events enter into the system.

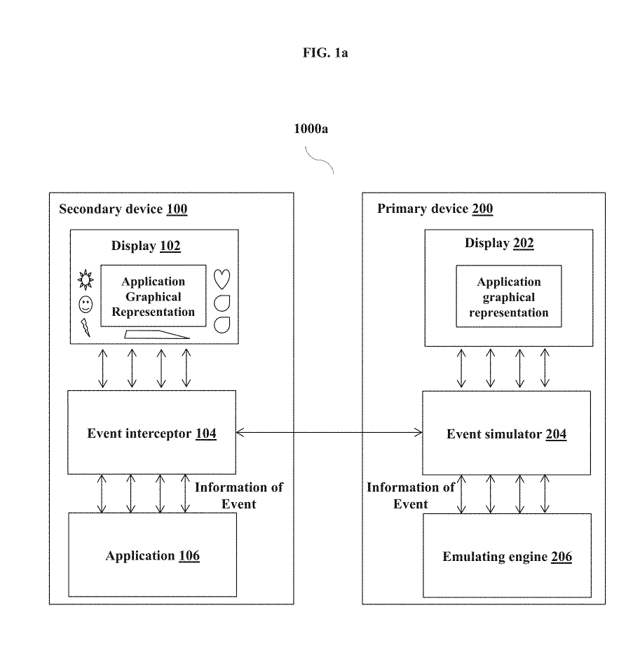

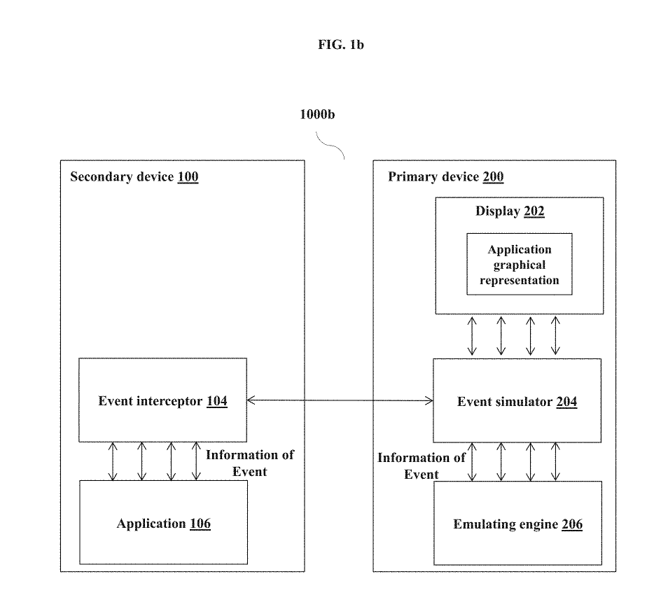

Referring now to the drawings and more particularly to FIGS. 1a through 13, where similar reference characters denote corresponding features consistently throughout the figure, there are shown preferred embodiments.

FIG. 1a illustrates a system 1000a for emulating an application 106 running in a secondary device 100 on a primary device 200 based on a detected event associated with the application 106 running in the secondary device 100, according to embodiments as disclosed herein. The system 1000a includes the secondary device 100 and the primary device 200. The secondary device 100 can be, for example but not limited to, a wearable device and an IoT device. The wearable device can be, for example but not limited to, a smart watch, a smart glass, a smart ring, a smart band, a sensor device, or the like. The IoT device refers to an internetworking of electronic devices connected and communicated with each other over a network which enables the electronic devices to collect and exchange data. In an embodiment, the primary device 200 acts as a slave device and the secondary device 100 acts as a master device. The secondary device 100 includes a display 102, an event interceptor 104, and an application 106. The primary device 200 can be, for example but not limited to, a laptop, a netbook, a tablet, smartphone, a Personal Digital Assistance (PDA) or the like. The primary device 200 includes a display 202, an event simulator 204, and an emulating engine 206.

The event interceptor 104 is configured to detect an event associated with the application 106 running in the secondary device 100. The event refers to an action generated by the secondary device 100 or an action from the user of the secondary device 100. The application 106 can be a native application installed in the secondary device 100 or a third party application. Based on the detected event, the display 102 is configured to display the graphical representation of the application 106 running in the secondary device 100. Further, the event interceptor 104 is configured to send information about the graphical representation to the primary device 200. In an embodiment, the event interceptor 104 is configured to send the information about the graphical representation to the primary device 200 using a direct delivery mechanism using a server (not shown).

In an embodiment, the event interceptor 104 is configured to send the information about the graphical representation to the primary device 200 using a cloud based application execution mechanism using the server.

In an embodiment, the event interceptor 104 is configured to send the information about the graphical representation to the primary device 200 by using at least one of an asynchronous communication technique, a callback event handler technique, a trigger technique, or the like.

The event simulator 204 is configured to receive the information about the graphical representation. In an embodiment, the information of the event is received at the event simulator 204 at a time unit different than a time unit at which the event is generated in the secondary device 100.

In an embodiment, a time unit at which the graphical representation of the application running in the at least secondary device 100 displayed on the primary device 200 is different than a time unit at which the at least one secondary device 100 displays the graphical representation.

In an embodiment, the difference is caused due to at least one of a periodic interval and a time taken to wait for the information to be received from a series of the secondary devices 100.

In an embodiment, a time unit at which the information of the event received at the primary device is different than a time unit at which the event is generated in the at least one secondary device.

In an embodiment, the emulation can be orchestrated in situations where the emulated application starts much later that the original application or the originator of the events and all the events delivered from the secondary device 100 are then replayed by the broking agent 202 or the service environment to the replicated application after it starts.

In an embodiment, delayed emulation allows a reestablishment of state on the replicated application much later than in the original application. In an embodiment, the delayed emulation does not require the entire event set to be delivered. In an embodiment, the replicated application reestablishes state using the events delivered to the service environment earlier by the original application which is later retrieved and delivered to the replicator.

After receiving the information about the graphical representation, the emulating engine 206 is configured to emulate the graphical representation of the application running in the secondary device 100. Further, the emulating engine 206 is configured to display the graphical representation of the application 106 running in the secondary device 100. The display 202 displays only the graphical representation of the application 106 running in the secondary device 100, whereas the display 102 displays the graphical representation of the application 106 along with additional icons as shown in the FIG. 1a.

In an embodiment, the emulation refers to the state replication between the various instances that are executing at the same time (with some delays).

In an embodiment, the emulation refers to the state replication between the various instances that are executing at the same time (without any delays).

In an embodiment, the emulating engine 206 is configured to concurrently display the graphical representation of the application 106 running in the secondary device 100.

In an embodiment, the graphical representation displays a state of the application 106 running in the secondary device 100. In an embodiment, the state of the application 106 is dynamically determined based on the information of the event associated with the application 106 running in the secondary device 100.

In an embodiment, the time unit at which the state of the application running in the at least secondary device on the primary device is different than a time unit at which the state of application changes in the at least one secondary device.

In an example, a first secondary device is a first smartwatch, a second secondary device is a second smartwatch, and a third secondary device is a smart band. The first and second smartwatches and the smart band are used for monitoring the user health information (like how much calories burned during the swimming or the like). The first and second smartwatches and the smart band detect the event associated with the application running in the corresponding first and second smartwatches and the smart band. The first and second smartwatches and the smart band send the information to a laptop. The laptop receives the information from the first and second smartwatches and the smart band and emulate the only graphical representation of the application 106 running in the first and second smartwatches and the smart band.

The FIG. 1a shows the limited overview of the system 1000a for emulating the application 106 running in the secondary device 100 on the primary device 200 but, it is to be understood that other embodiments are not limited thereto. Further, the system 1000a can include any number any number of hardware or software components communicating with each other. By way of illustration, both an application running on a device and the device itself can be a component.

FIG. 1b illustrates a system 1000b for emulating the application 106 running in the secondary device 100 on the primary device 200 based on the received information about the graphical representation of the secondary device 100, according to embodiments as disclosed herein. The operation and functionality of the secondary device 100 and the primary device 200 are explained in conjunction with the FIG. 1a. In an embodiment, the secondary device 100 does not comprises a display screen, a user interface or combination of the display screen and the user interface. In an embodiment, the application 106, running in the secondary device 100, does not comprises the user interface. In an embodiment, the secondary device 100 is a sensor device without a display screen.

The event interceptor 104 is configured to receive the information about the graphical representation running in the secondary device 100. Based on the information, the event interceptor 104 is configured to send the information about the graphical representation to the primary device 200. The event simulator 204 is configured to receive the information about the graphical representation. In an embodiment, the information of the event is received at the event simulator 204 at the time unit different than the time unit at which the event is generated in the secondary device 100.

After receiving the information about the graphical representation, the emulating engine 206 is configured to emulate the graphical representation of the application 106 running in the secondary device 100. Further, the emulating engine 206 is configured to display the graphical representation of the application 106 running in the secondary device 100.

In an embodiment, the graphical representation displays the state of the application 106 running in the secondary device 100. In an embodiment, the state of the application 106 is dynamically determined based on the information of the event associated with the application 106 running in the secondary device 100.

In an example, a series of sensors deliver data to a local User Interface (UI) near a patient bed. And an ongoing basis all the data gets updated. A doctor at his or her office wants to see a replicated version of the application at a later time and look at a vital statistics of the patient under observation. The events are then delivered to the doctor's computer or cellphone where the replicated application runs.

The FIG. 1b shows the limited overview of the system 1000b for emulating the application 106 running in the secondary device 100 on the primary device 200 but, it is to be understood that other embodiments are not limited thereto. Further, the system 1000b can include any number any number of hardware or software components communicating with each other. By way of illustration, both an application running on a device and the device itself can be a component.

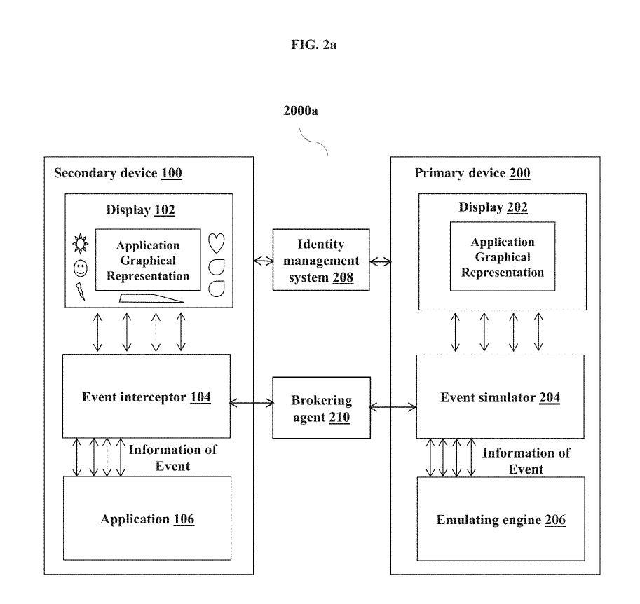

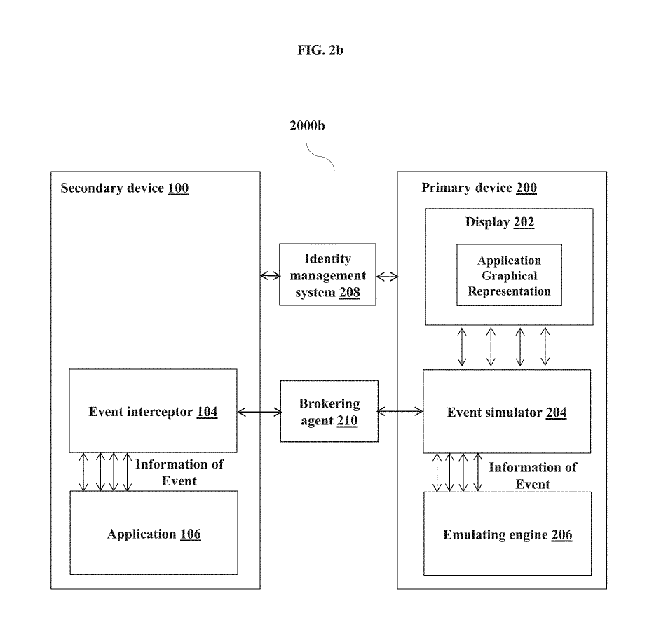

FIG. 2a illustrates a system 2000a for emulating the application 106 running in the secondary device 100 on the primary device 200, through a brokering agent 210, based on the detected event associated with the application 106 running in the secondary device 100, according to embodiments as disclosed herein. The system 2000a includes the secondary device 100, the primary device 200, the brokering agent 210, and an identity management system 208. The secondary device 100 includes the display 102, the event interceptor 104, and the application 106. The primary device 200 includes the display 202, the event simulator 204, and the emulating engine 206. The event interceptor 104 is configured to detect the event associated with the application 106 running in the secondary device 100. Based on the detected event, the display 102 is configured to display the graphical representation of the application 106 running in the secondary device 100.

Further, the event interceptor 104 is configured to send the information about the graphical representation to the primary device 200. The event simulator 204 is configured to receive the information about the graphical representation. In an embodiment, the information of the event is received at the event simulator 204 at the time unit different than the time unit at which the event is generated in the secondary device 100.

In an embodiment, prior to receiving the information about the graphical representation, the identity management system 208 is configured to identify a user of the secondary device 100. Based on the identity of the user of the secondary device 100, the identity management system 208 is configured to authorize a level of access to the graphical representation of the application 106 running in the secondary device 100 to the user of the primary device 200. In an embodiment, the authorizing level is set by the user of the secondary device 100. In an embodiment, the authorizing level is set by the user of the primary device 200. In an embodiment, the authorizing level can be dynamically changed at any time by the user of the primary device 200.

In an example, the smart watch (i.e., secondary device 100) is used by the patient and is used for monitoring the patient health information. A computer is operated by the nurse and the computer has limited access to view the patient health information, whereas the laptop is operated by the surgeon and has full access to monitor the patient health information. In an embodiment, the access level is set by the patient. In an embodiment, the access level is set by the surgeon. Once the computer and the laptop receive the graphical representation of the application running in the smart watch, the computer and the laptop emulate the graphical representation of the application running in the smart watch based on the access level.

In an embodiment, the identity management system 208 is configured to store a relationship of each of the secondary device 100 with corresponding user to dynamically determine the identity of the user of the secondary device 100.

In an embodiment, the identity management system 208 is configured to dynamically update the relationship when the user of the secondary device 100 is changed.

In an embodiment, the relationship is setup by the identity management system 208 to deliver the information of the event associated with the application 106 running in the secondary device 100 to the primary device 200 using the brokering agent 210.

After the authorizing procedure, the emulating engine 206 is configured to emulate the graphical representation of the application 106 running in the secondary device 100. Further, the emulating engine 206 is configured to display the graphical representation of the application 106 running in the secondary device 100. The display 202 displays only the graphical representation of the application 106 running in the secondary device 100, whereas the display 102 displays the graphical representation of the application 106 along with additional icons as shown in the FIG. 2a.

In an embodiment, the brokering agent 210 is configured to determine the at least one portion of the graphical representation of the application 106 running in the at least one secondary device 100 to be emulated on the primary device 200.

In an embodiment, the graphical representation displays the state of the application 106 running in the secondary device 100. In an embodiment, the state of the application 106 is dynamically determined based on the information of the event associated with the application 106 running in the secondary device 100.

The FIG. 2a shows the limited overview of the system 2000a for emulating the application 106 running in the secondary device 100 on the primary device 200 but, it is to be understood that other embodiments are not limited thereto. Further, the system 2000a can include any number any number of hardware and software components communicating with each other. By way of illustration, both an application running on a device and the device itself can be the component.

FIG. 2b illustrates a system 2000b for emulating the application 106 running in the secondary device 100 on the primary device 200, through the brokering agent 210, based on the received information about the graphical representation of the secondary device 100, according to embodiments as disclosed herein. The system 2000b includes the secondary device 100, the primary device 200, the brokering agent 210, and the identity management system 208. The secondary device 100 includes the event interceptor 104 and the application 106. The primary device 200 includes the display 202, the event simulator 204, and the emulating engine 206. The event interceptor 104 is configured to receive the information about the graphical representation running in the secondary device 100. Further, the event interceptor 104 is configured to send the information about the graphical representation to the primary device 200. The event simulator 204 is configured to receive the information about the graphical representation. In an embodiment, the information of the event is received at the event simulator 204 at the time unit different than the time unit at which the event is generated in the secondary device 100.

In an embodiment, prior to receiving the information about the graphical representation, the identity management system 208 is configured to identify the user of the secondary device 100. Based on the identity of the user of the secondary device 100, the identity management system 208 is configured to authorize the level of access to the graphical representation of the application 106 running in the secondary device 100 to the user of the primary device 200.

In an embodiment, the identity management system 208 is configured to store the relationship of each of the secondary device 100 with corresponding user to dynamically determine the identity of the user of the secondary device 100.

In an example, a medical device that is a wearable can be reused for instance on a different patient or a worker device can be used by a different employee. The re-association happens in a backend identity management system using the authorization system 406. Based on the re-association, the identity management system 208 stores the relationship of each of the medical device or the worker device with the corresponding user.

In an embodiment, the identity management system 208 is configured to dynamically update the relationship when the user of the secondary device 100 is changed.

In an embodiment, the relationship is setup by the identity management system 208 to deliver the information of the event associated with the application 106 running in the secondary device 100 to the primary device 200 using the brokering agent 210.

After the authorizing procedure, the emulating engine 206 is configured to emulate the graphical representation of the application 106 running in the secondary device 100. Further, the emulating engine 206 is configured to display the graphical representation of the application 106 running in the secondary device 100.

In an embodiment, the graphical representation displays the state of the application 106 running in the secondary device 100. In an embodiment, the state of the application 106 is dynamically determined based on the information of the event associated with the application 106 running in the secondary device 100.

The FIG. 2b shows the limited overview of the system 2000b for emulating the application 106 running in the secondary device 100 on the primary device 200 but, it is to be understood that other embodiments are not limited thereto. Further, the system 2000b can include any number any number of hardware and software components communicating with each other. By way of illustration, both an application running on a device and the device itself can be the component.

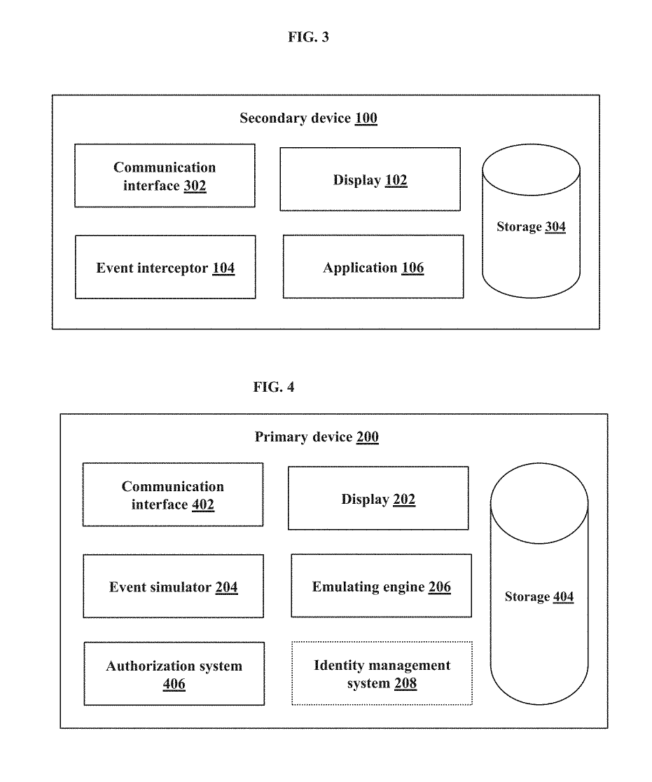

FIG. 3 illustrates various units included in the secondary device 100, according to embodiments as disclosed herein. The secondary device 100 includes the display 102, the event interceptor 104, the application 106, a communication interface 302, and a storage 304. The event interceptor 104 is configured to detect the event associated with the application 106 running in the secondary device 100. The display 116 is configured to display the graphical representation of the application 106 running in the secondary device 100 based on the event. The communication interface 302 is configured to send the information about the graphical representation to the primary device 200.

The communication interface 302 is configured for communicating internally between internal units and with external devices via one or more networks. The storage 304 may include one or more computer-readable storage media. The storage unit 304 may include non-volatile storage elements. Examples of such non-volatile storage elements may include magnetic hard disc, optical discs, floppy discs, flash memories, or forms of electrically programmable memories (EPROM) or electrically erasable and programmable (EEPROM) memories. In addition, the storage 304 may, in some examples, be considered a non-transitory storage medium. The term “non-transitory” may indicate that the storage medium is not embodied in a carrier wave or a propagated signal. However, the term “non-transitory” should not be interpreted that the storage 304 is non-movable. In some examples, the storage 304 can be configured to store larger amounts of information than a memory. In certain examples, a non-transitory storage medium may store data that can, over time, change (e.g., in Random Access Memory (RAM) or cache).

Although the FIG. 3 shows the units of the secondary device 100 but it is to be understood that other embodiments are not limited thereon. In other embodiments, the secondary device 100 may include less or more number of units. Further, the labels or names of the units are used only for illustrative purpose and does not limit the scope of the invention. One or more units can be combined together to perform same or substantially similar function to emulate the application 106 running in the secondary device 100 on the primary device 200.

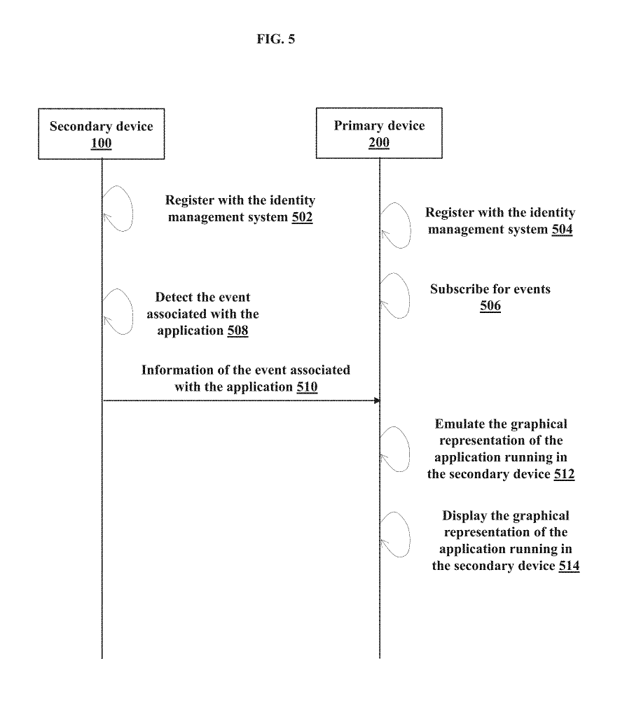

FIG. 4 illustrates various units included in the primary device 200, according to embodiments as disclosed herein. The primary device 200 includes the display 202, the event simulator 204, the emulating engine 206, the identity management system 208, and a communication interface 402, a storage 404, and an authorization system 406. The communication interface 402 is configured to receive the information about the graphical representation of the application 106 running in the secondary device 100. Based on the reception, the event simulator 204 is configured to receive the information about the graphical representation. In an embodiment, the information of the event is received at the event simulator 204 at the time unit different than the time unit at which the event is generated in the secondary device 100.

In an embodiment, the identity of the secondary device 100 and the user and the relationship of the secondary device 100 and the user are matched by the authorization system 406. The matches can change on an ongoing basis.

In an example, the medical device that is the wearable can be reused for instance on a different patient or a worker device can be used by a different employee. The re-association happens in a backend identity management system using the authorization system 406.

In an embodiment, the association is setup to deliver the event appropriately through a broking agent 202.

In an embodiment, prior to receiving the information about the graphical representation, the identity management system 208 is configured to identify the user of the secondary device 100. Based on the identity of the user of the secondary device 100, the identity management system 208 is configured to authorize the level of access to the graphical representation of the application 106 running in the secondary device 100 to the user of the primary device 200.

In an embodiment, the identity management system 208 is configured to store the relationship of each of the secondary device 100 with corresponding user to dynamically determine the identity of the user of the secondary device 100.

In an embodiment, the identity management system 208 is configured to dynamically update the relationship when the user of the secondary device 100 is changed.

In an embodiment, the relationship is setup by the identity management system 208 to deliver the information of the event associated with the application running in the secondary device 100 to the primary device 200 using the brokering agent 210.

After the authorizing procedure, the emulating engine 206 is configured to emulate the graphical representation of the application 106 running in the secondary device 100. Further, the emulating engine 206 is configured to display the graphical representation of the application 106 running in the secondary device 100.

In an embodiment, the graphical representation displays the state of the application 106 running in the secondary device 100. In an embodiment, the state of the application 106 is dynamically determined based on the information of the event associated with the application 106 running in the secondary device 100.

In an embodiment, the administration of the application 106 is by a cloud based administration using a third party application, a web panel, or the like. The administrator assigns the execution permissions and is able to decide which users and roles can perform what actions on the application instances.

Further, the communication interface 402 is configured for communicating internally between internal units and with external devices via one or more networks. The storage 404 may include one or more computer-readable storage media. The storage 404 may include non-volatile storage elements. Examples of such non-volatile storage elements may include magnetic hard disc, optical discs, floppy discs, flash memories, or forms of electrically programmable memories (EPROM) or electrically erasable and programmable (EEPROM) memories. In addition, the storage 404 may, in some examples, be considered a non-transitory storage medium. The term “non-transitory” may indicate that the storage medium is not embodied in a carrier wave or a propagated signal. However, the term “non-transitory” should not be interpreted that the storage 404 is non-movable. In some examples, the storage 404 can be configured to store larger amounts of information than a memory. In certain examples, a non-transitory storage medium may store data that can, over time, change (e.g., in Random Access Memory (RAM) or cache).

In an embodiment, the identity management system 208 is operated within the primary device 200. In another embodiment, the identity management system 208 is operated outside the primary device 200.

Although the FIG. 4 shows the units of the primary device 200 but it is to be understood that other embodiments are not limited thereon. In other embodiments, the primary device 200 may include less or more number of units. Further, the labels or names of the units are used only for illustrative purpose and does not limit the scope of the invention. One or more units can be combined together to perform same or substantially similar function to emulate the application 106 running in the secondary device 100 on the primary device 200.

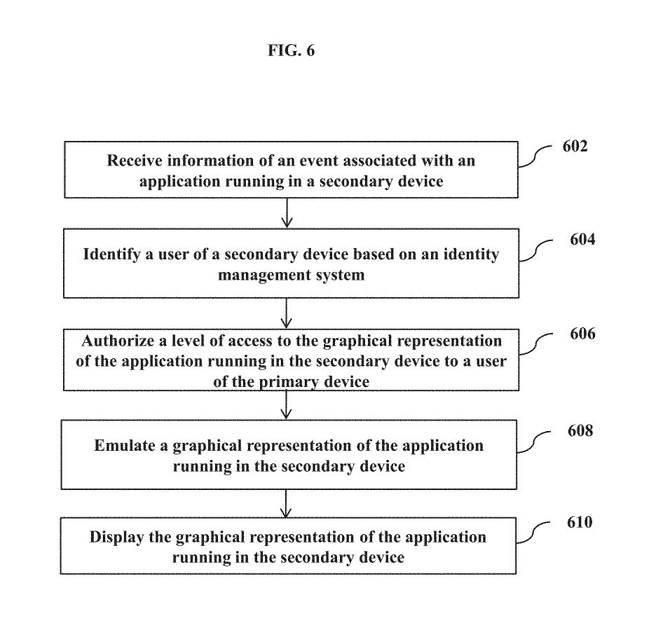

FIG. 5 is a sequence diagram illustrating a step by step procedure involved in emulating the application 106 running in the secondary device 100 on the primary device 200, according to embodiments as disclosed herein. The secondary device 100 registers (502) with the identity management system 208. The primary device 200 registers (504) with the identity management system 208. The primary device 200 subscribes (506) for the events. The secondary device 100 detects (508) the event associated with the application 106. After detecting the event, the secondary device 100 sends (510) the information of the event associated with the application 106 to the primary device 200. The primary device 200 emulates (512) the graphical representation of the application 106 running in the secondary device 100. The primary device 200 displays (514) the graphical representation of the application 106 running in the secondary device 100.

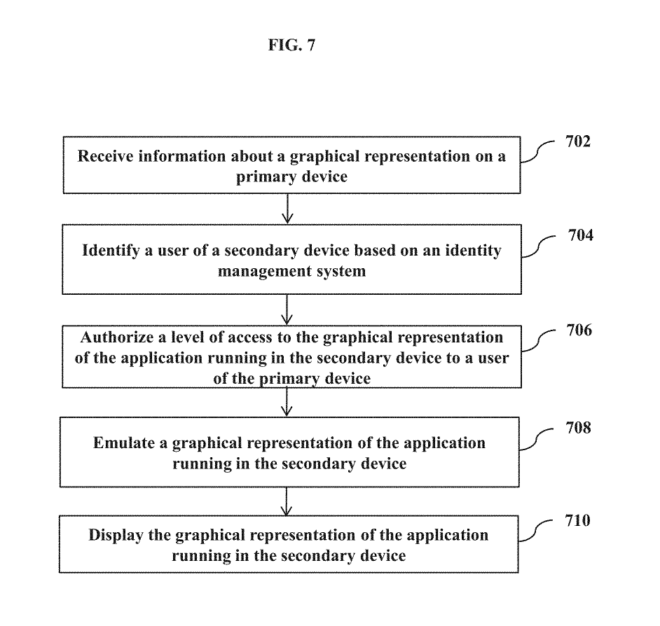

FIG. 6 is a flow diagram illustrating a method for emulating the application 106 running in the plurality of secondary devices 100 on the primary device 200 based on the detected event associated with the application 106 running in the secondary device 100, according to embodiments as disclosed herein. At step 602, the method includes receiving the information of the event associated with the application 106 running in the secondary device 100. In an embodiment, the method allows the communication interface 402 to receive information of the event associated with the application 106 running in the secondary device 100. At step 604, the method includes identifying the user of the secondary device 100 using the identity management system 208. In an embodiment, the method allows the authorization system 406 to identify the user of the secondary device 100 using the identity management system 208. At step 606, the method includes authorizing the level of access to the graphical representation of the application 106 running in the secondary device 100 to the user of the primary device 200. In an embodiment, the method allows the authorization system 406 to authorize the level of access to the graphical representation of the application 106 running in the secondary device 100 to the user of the primary device 200.

At step 608, the method includes emulating the graphical representation of the application 106 running in the secondary device 100. In an embodiment, the method allows the emulating engine 206 to emulate the graphical representation of the application 106 running in the secondary device 100. At step 610, the method includes displaying the graphical representation of the application 106 running in the secondary device 100. In an embodiment, the method allows the display to display the graphical representation of the application 106 running in the secondary device 100.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

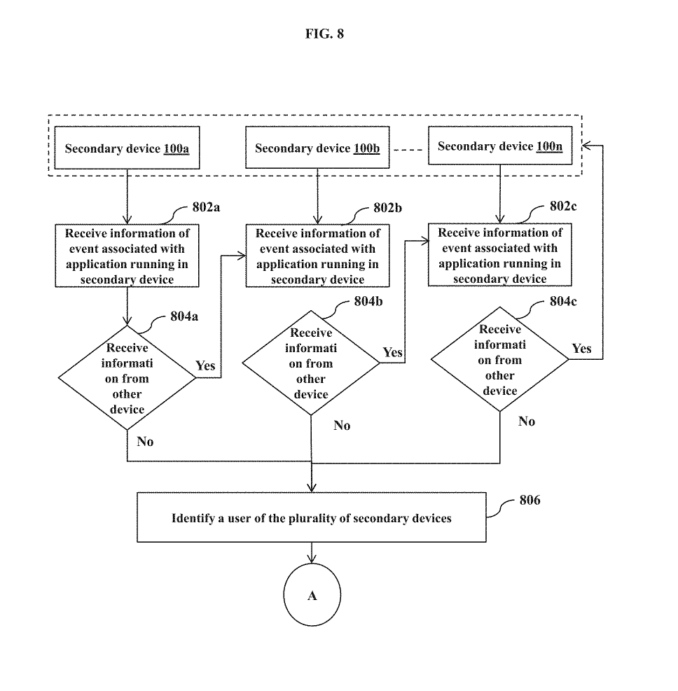

FIG. 7 is a flow diagram illustrating a method for emulating the application 106 running in the plurality of secondary device 100 on the primary device 200 based on the received information about the graphical representation of the secondary device 100, according to embodiments as disclosed herein. At step 702, the method includes receiving the information about the graphical representation on the primary device 200. In an embodiment, the method allows the communication interface 402 to receive the information about the graphical representation on the primary device 200. At step 704, the method includes identifying the user of the secondary device 100 using the identity management system 208. In an embodiment, the method allows the authorization system 406 to identify the user of the secondary device 100 using the identity management system 208. At step 706, the method includes authorizing the level of access to the graphical representation of the application 106 running in the secondary device 100 to the user of the primary device 200. In an embodiment, the method allows the authorization system 406 to authorize the level of access to the graphical representation of the application 106 running in the secondary device 100 to the user of the primary device 200.

At step 708, the method includes emulating the graphical representation of the application 106 running in the secondary device 100. In an embodiment, the method allows the emulating engine 206 to emulate the graphical representation of the application 106 running in the secondary device 100. At step 710, the method includes displaying the graphical representation of the application 106 running in the secondary device 100. In an embodiment, the method allows the display 202 to display the graphical representation of the application 106 running in the secondary device 100.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

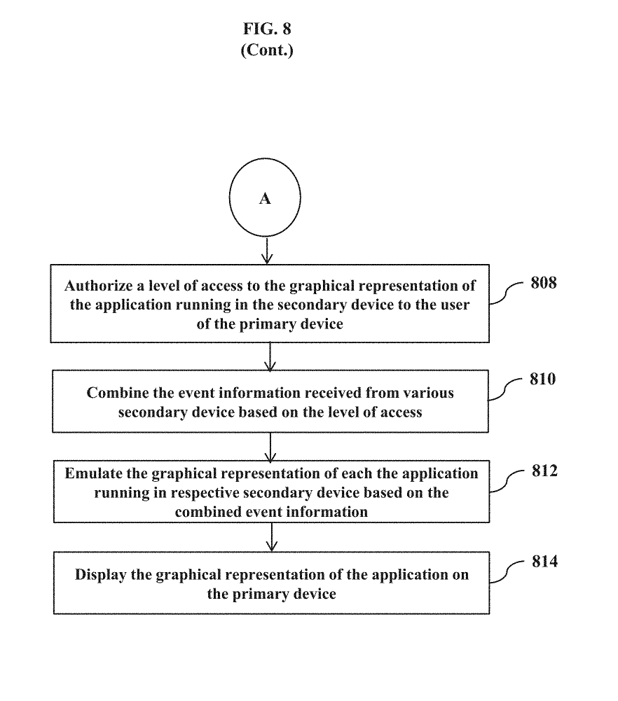

FIG. 8 is a flow diagram illustrating a method for emulating the application 106, running in the plurality of secondary devices 100a-100n, on the primary device 200 based on the identify the user of the plurality of secondary devices 100a-100n, according to embodiments as disclosed herein.

At steps 802a to 802c, the method includes receiving the information of event associated with the application 106 running in the corresponding secondary devices 100a-100n. In an embodiment, the method allows the communication interface 402 to receive the information of event associated with application 106 running in the corresponding secondary devices 100a-100n. At steps 804a-804c, the method includes determining whether information is received from other secondary devices. In an embodiment, the method allows the event simulator 204 to determine whether information is received from other secondary devices.

At step 806, the method includes identifying the user of the plurality of secondary device 100a-100n. In an embodiment, the method allows the identity management system 208 to identify the user of the plurality of secondary device 100a-100n. At step 808, the method includes authorizing the level of access to the graphical representation of the application 106 running in the secondary devices 100a-100n to the user of the primary device 200. In an embodiment, the method allows the authorization system 406 to authorize the level of access to the graphical representation of the application 106 running in the secondary devices 100a-100n to the user of the primary device 200.

At step 810, the method includes combining the event information received from the secondary device 100a-100n based on the level of access. In an embodiment, the method allows the authorization system 406 to combine the event information received from the secondary device 100a-100n based on the level of access. At step 812, the method includes emulating the graphical representation of each the application 106 running in respective secondary device 100a-100n based on the combined event information. In an embodiment, the method allows the emulating engine 206 to emulate the graphical representation of each the application 106 running in respective secondary device 100a-100n based on the combined event information.

At step 814, the method includes displaying the graphical representation of the application 106 on the primary device 200. In an embodiment, the method allows the display 202 to display the graphical representation of the application 106 on the primary device 200.

In an example, a series of sensor devices send the data to a local UI near a patient bed. And an ongoing basis all the data gets updated on the patient monitor device. A surgeon at his or her office wants to see a replicated version of the application at a later time and look at a vital statistics of the patient under observation. The events are then all delivered to the surgeon's laptop or smartphone where the replicated application runs.

The various actions, acts, blocks, steps, or the like in the flow diagram may be performed in the order presented, in a different order or simultaneously. Further, in some embodiments, some of the actions, acts, blocks, steps, or the like may be omitted, added, modified, skipped, or the like without departing from the scope of the invention.

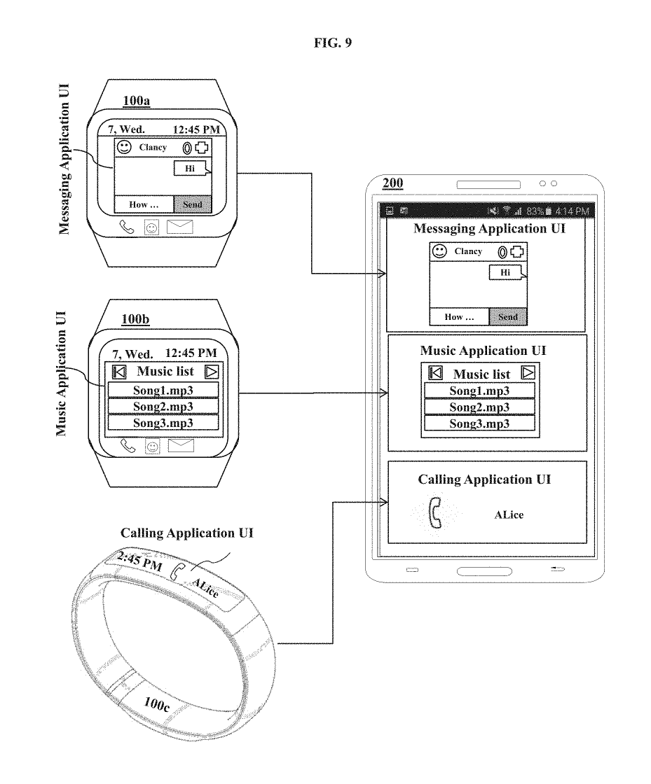

FIG. 9 is an example illustration in which the application 106 running in the plurality of secondary devices 100a-100c including the display is emulated on the primary device 200, according to embodiments as disclosed herein. The plurality of secondary devices 100a-100c detect the corresponding event associated with the application (i.e., messaging application, music application, and calling application) running in each of the secondary device 100a-100c using the event interceptor 104. Based on the detected event, each display of the plurality of secondary devices 100a-100c display the graphical representation of the messaging application, music application, and calling application running in the secondary devices 100a-100c. Further, the secondary devices 100a-100c send the information about the graphical representation to the primary device 200. The primary device 200 receives the information about the graphical representation. After receiving the information about the graphical representation, the emulating engine 206 emulates the graphical representation of the messaging application, the music application, and the calling application running in the secondary devices 100a-100c. Further, the display displays the only graphical representation of the messaging application, the music application, and the calling application running in the secondary device 100a to 100c, whereas the displays of the secondary devices 100a to 100c display the graphical representation of the applications along with additional items as shown in the FIG. 9.

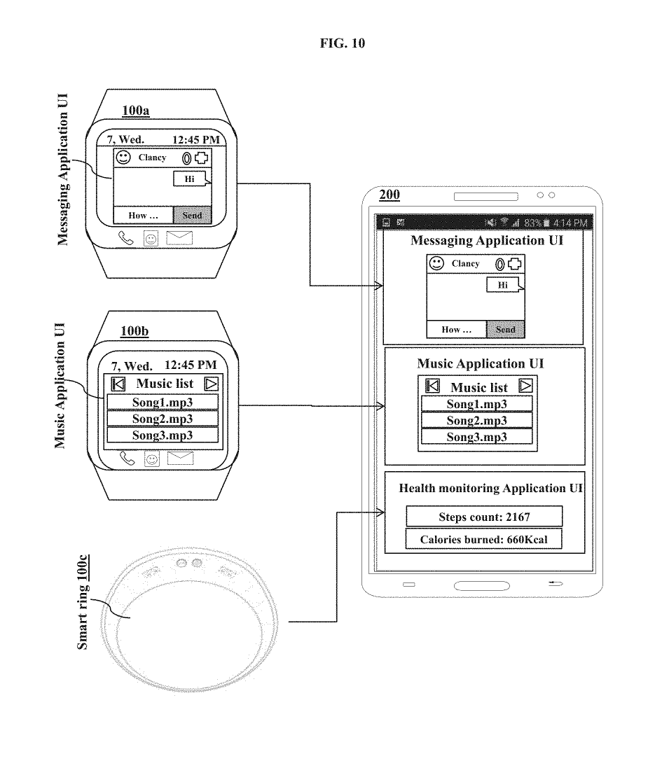

FIG. 10 is an example illustration in which the application 106 running in the plurality of secondary devices 100a-100c with or without display is emulated on the primary device 200, according to embodiments as disclosed herein. The plurality of secondary devices 100a-100c detect the corresponding event associated with the application (i.e., messaging application, music application, and health monitoring application) running in each secondary devices 100a-100c using the event interceptor 104. Based on the detected event, each display of the plurality of secondary devices 100a and 100b display the graphical representation of the messaging application and the music application running in the secondary devices 100a and 100b. The secondary device 100c does not have the display, so the secondary device 100c does not display any information. Further, the secondary devices 100a-100c send the information related to the events to the primary device 200. The primary device 200 receives the information about the events. After receiving the information, each emulating engine emulates the graphical representation of the messaging application, the music application, and the health monitoring application running in the secondary devices 100a-100c. Further, the display of the primary device 200 displays only the graphical representation of the messaging application, the music application, and the health monitoring application running in the secondary devices 100a-100c, whereas the displays of the secondary devices 100a and 100b display the graphical representation of the applications along with additional items and the secondary device 100c does not display any information as shown in the FIG. 10.

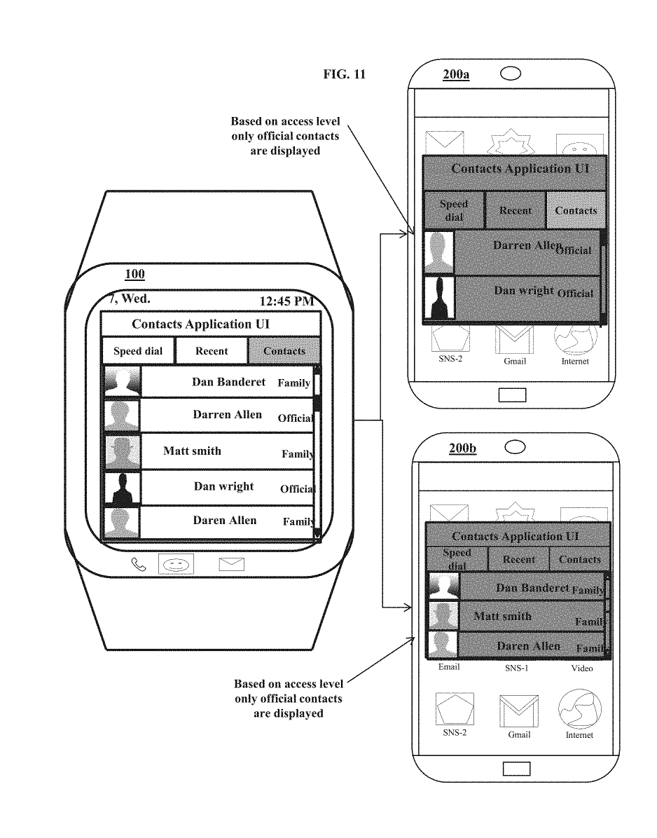

FIG. 11 is an example illustration in which the application running in the secondary device 100 is emulated on the primary devices 200a and 200b based on the access level, according to embodiments as disclosed herein. The user of the secondary device 100 saves the contact in two groups (i.e., official and family) in the contact application. Further, the user of the secondary device 100 provides access to the other based on the personal settings. Here, the user of the secondary device 100 provides only official contacts (i.e., colleagues) access to the user of the primary device 200a. The user of the secondary device 100 provides only personal contacts (i.e., family) access to the user of the primary device 200b. Once the secondary device 100 utilizes the contact application. The secondary devices 100 sends the information related to the contact application to the primary device 200. The primary device 200 receives the information about the contact application. After receiving the information, based on the access level, the primary device 200a only emulates the official contacts related graphical representation of the contact application running in the secondary device 100. Further, the display of the primary device 200 only displays the official contacts information on the primary device 200a, whereas the primary device 200b only emulates the personal contacts related graphical representation of the contact application running in the secondary device 100. Further, the display only displays the personal contacts information on the primary device 200b.

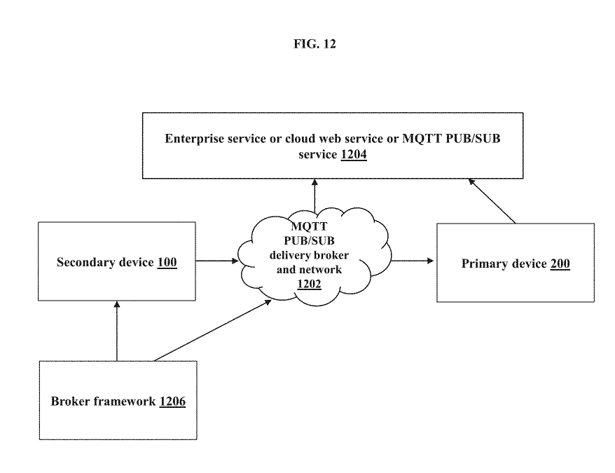

FIG. 12 illustrates a system for emulating the application 106 running in the secondary device 100 on the primary device 200 over an IoT network, according to embodiments as disclosed herein. The system includes the secondary device 100, the primary device 200, a Message Queue Telemetry Transport Publish-Subscribe (MQTT PUB/SUB) delivery broker and network 1202, an enterprise service or a cloud web service or a MQTT PUB/SUB service 1204, and a broker framework 1206. The secondary device 100 is itself configured to detect the information corresponding to the graphical representation running in the secondary device 100. Based on the information, the secondary device 100 is configured to send the information about the graphical representation to the primary device 200 over the MQTT PUB/SUB delivery broker and network 1202. The MQTT PUB/SUB delivery broker and network 1202 is communicated with the enterprise service or the cloud web service or the MQTT PUB/SUB service 1204 and the broker framework 1206.

In an embodiment, prior to receiving the information about the graphical representation, the broker framework 1206 is configured to identify the user of the secondary device 100. Based on the identity of the user of the secondary device 100, the broker framework 1206 is configured to authorize the level of access to the graphical representation of the application 106 running in the secondary device 100 to the user of the primary device 200.

In an embodiment, the broker framework 1206 is configured to store the relationship of each of the secondary device 100 with corresponding user to dynamically determine the identity of the user of the secondary device 100.

In an embodiment, the broker framework 1206 utilizes the MQTT handles both the access management and security as well as the event delivery between the primary device 200 and the secondary device 100.

Further, the primary device 200 is configured to receive the information about the graphical representation. After receiving the information about the graphical representation, the emulating engine of the primary device 200 is configured to emulate the graphical representation of the application running in the secondary device 100. Further, the emulating engine 206 of the primary device 110 is configured to display the graphical representation of the application 106 running in the secondary device 100.

In an example, the smart watch is communicated with the enterprise network or the cloud web service network in order to send the event actions performed on the smart watch to a server. By using the communication interface, the smart watch and the smart phone will be able to interact with each other using SASocket and SAAgent classes in an Android Java and its counterpart in the smart watch using the Javascript. The smart watch will capture and relay its actions to the Android host app running in the smart watch. The Android app will then make necessary calls to a webservice to relay the actions performed on the smart watch. The Webservice sends the information to the smart phone. The Webservice will then evaluate the received information and imitate the actions upon the emulator on the smart phone. Such that, the action or event occurring in the smart watch is replicated on the smart phone using a server emulator.

In another example, when the actions on the server emulator or any other service on the server that generates the data upon actions on the smart watch, the data is relayed back in reverse order in the smart phone.

In another example, the smart watch detects the event by a Jquery language when the button is pressed or any other element is pressed. After detecting the event, the event along with identification will send to the wearable emulator on the server. The wearable emulator emulates the application running in the smart watch on the smart phone using a webservice, an XMLHttpRequest or the like.

In an example, the information generating from that sensor device is captured and stored in the form of json or so. And the information is relayed to on a third party application associated with the sensor device and the generated information is stored in the storage. Once the smart phone is connected with the sensor device. The sensor device sends the information to the smart phone. The smart phone emulates the third party application associated with the sensor device on the smart phone.

In an example, a heart rate monitoring sensor is remotely communicated with a personal computer. Further, the heart rate monitoring sensor is connected with a GUI of a patient monitor. The patient monitor listen the sensor operation. Based on the listening operation, all the data generating from that sensor is captured and stored in the form of json in the patient monitor. This data is relayed to the GUI, where it is stored until the personal computer connects to the patient monitor. This sensor data is captured in the same way as the input events are captured but in the background. This sensor is categorized as ‘sensor’ events and will help remote system differentiate between the events. When the personal computer connects to the patient monitor, this events are downloaded and differentiated. If the event is of type input then the normal user input will happen. But when the event type is ‘sensor’ the data of the event will be fed to the proxy sensor which will emulate the sensor. So this sensor reading will be captured on remote system and the UI readings will also be updated. Similar to the input events this sensor events will also be deleted from the server database once the event is fetched by remote system.

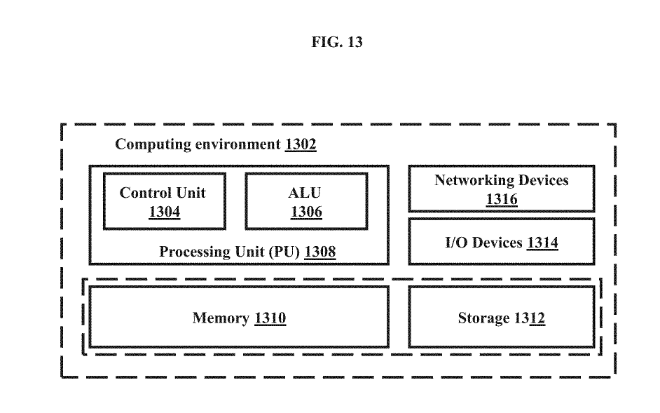

FIG. 13 illustrates a computing environment 1302 implementing a mechanism for emulating the application 106 running in the secondary device 100 on the primary device 200, according to an embodiment as disclosed herein. As depicted in the figure, the computing environment 1302 comprises at least one processing unit 1308 that is equipped with a control unit 1304, an Arithmetic Logic Unit (ALU) 1306, a memory 1310, a storage unit 1312, a plurality of networking devices 1316 and a plurality Input output (I/O) devices 1314. The processing unit 1308 is responsible for processing the instructions of the technique. The processing unit 1008 receives commands from the control unit 1304 in order to perform its processing. Further, any logical and arithmetic operations involved in the execution of the instructions are computed with the help of the ALU 1306.

The overall computing environment 1302 can be composed of multiple homogeneous or heterogeneous cores, multiple CPUs of different kinds, special media and other accelerators. The processing unit 1308 is responsible for processing the instructions of the technique. Further, the plurality of processing units 1304 may be located on a single chip or over multiple chips.

The technique comprising of instructions and codes required for the implementation are stored in either the memory unit 1310 or the storage 1312 or both. At the time of execution, the instructions may be fetched from the corresponding memory 1310 or storage 1312, and executed by the processing unit 1308.

In case of any hardware implementations various networking devices 1316 or external I/O devices 1314 may be connected to the computing environment 1302 to support the implementation through the networking unit and the I/O device unit.

The embodiments disclosed herein can be implemented through at least one software program running on at least one hardware device and performing network management functions to control the elements. The elements shown in the FIGS. 1a to 13 include blocks which can be at least one of a hardware device, or a combination of hardware device and software module.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A primary device for emulating an application running in at least one secondary device, the primary device comprising:
a memory;
a processor couple to the memory;
an emulating engine, couple to the processor, configured to:
receive information of an event associated with the application running in the secondary device;
emulate a graphical representation of the application running in the secondary device based on the information of the event; and
display the graphical representation of the application running in the secondary device.

2. The device of claim 1, wherein a time unit at which the graphical representation of the application running in the at least secondary device displayed on the primary device is different than a time unit at which the at least one secondary device displays the graphical representation.

3. The device of claim 2, wherein the difference is caused due to at least one of a periodic interval and a time taken to wait for the information to be received from a series of the secondary devices.

4. The device of claim 1, wherein emulate, by the emulating engine, the graphical representation of the application running in the secondary device based on the information of the event comprising:
identify a user of the secondary device based on an identity management system;
authorize a level of access to the graphical representation of the application running in the secondary device to a user of the primary device based on the identity of the user of the secondary device; and
emulate on the primary device at least one portion of the graphical representation of the application running in the secondary device based on the access level of the user of the primary device.

5. The device of claim 4, wherein the identity management system is configured to store a relationship of each of the secondary device with corresponding user to dynamically determine the identity of the user of the at least one secondary device, wherein the identity management system is configured to dynamically update the relationship when a user of the at least one secondary device is changed.

6. The device of claim 4, wherein the relationship is setup by the identity management system to deliver the information of the event associated with the application running in the secondary device to the primary device using a brokering agent, wherein the brokering agent is configured to determine the at least one portion of the graphical representation of the application running in the at least one secondary device to be emulated on the primary device.

7. The device of claim 1, wherein a time unit at which the information of the event received at the primary device is different than a time unit at which the event is generated in the at least one secondary device.

8. The device of claim 1, wherein the graphical representation displays a state of the application running in the at least one secondary device, wherein the state of the application is dynamically determined based on the information of the event associated with the application running in the at least one secondary device, wherein a time unit at which the state of the application running in the at least secondary device on the primary device is different than a time unit at which the state of application changes in the at least one secondary device.

9. The device of claim 1, wherein the secondary device is one of a wearable device and an Internet of Things (IoT) device.

10. The device of claim 1, wherein the secondary device does not comprises at least one of a display screen and a user interface.

11. The device of claim 1, wherein the application, running in the secondary device, does not comprises a user interface.

12. A primary device for emulating an application running in at least one secondary device, the primary device comprising:
a memory;
a processor couple to the memory;
an emulating engine, couple to the processor, configured to:
receive information about a graphical representation of an application running in the at least one secondary device;
emulate the graphical representation of the application running in the at least one secondary device; and
display the graphical representation of the application running in the at least one secondary device, wherein a time unit at which the graphical representation of the application running in the secondary device displayed on the primary device is different than a time unit at which the at least one secondary device displays the graphical representation.

13. The device of claim 12, wherein the difference caused due to at least one of a periodic interval and a time taken to wait for the information to be received from a series of secondary devices.

14. The device of claim 12, wherein emulate the graphical representation of the application running in the at least one secondary device comprising:
identify a user of the secondary device based on an identity management system, wherein the information of the event associated with the application running in the primary device corresponds to the user of the secondary device;
authorize an level of access to the graphical representation of the of the application running in the secondary device to a user of the primary device based on the identity of the user of the primary device; and
emulate the graphical representation of the application running in the secondary device on the primary device based on the access level of the user of the primary device.

15. The device of claim 14, wherein the identity management system stores a relationship of each of the secondary device with corresponding user to dynamically determine the identity of the user of the at least one secondary device, wherein the identity management system dynamically update the relationship when a user of the at least one secondary device is changed.

16. The device of claim 14, wherein the relationship is setup by the identity management system to deliver the information of the event associated with the application running in the secondary device to the primary device using a brokering agent, wherein the brokering agent determines the at least one portion of the graphical representation of the application running in the at least one secondary device to be emulated on the primary device.

17. The device of claim 12, wherein the graphical representation displays a state of the application running in the at least one secondary device, wherein the state of the application is dynamically determined based on the information of the event associated with the application running in the at least one secondary device, wherein a time unit at which the state of the application running in the at least secondary device on the primary device is different than a time unit at which the state of application changes in the at least one secondary device.

18. A method for emulating an application, running in at least one secondary device, on a primary device, the method comprising:
receiving, by the primary device, information of an event associated with the application running in the secondary device;
emulating, by the primary device, a graphical representation of the application running in the secondary device based on the information of the event; and
displaying, by the primary device, the graphical representation of the application running in the secondary device.

19. The method of claim 18, wherein a time unit at which the graphical representation of the application running in the at least secondary device displayed on the primary device is different than a time unit at which the at least one secondary device displays the graphical representation.

20. The method of claim 19, wherein the difference is caused due to at least one of a periodic interval and a time taken to wait for the information to be received from a series of the secondary devices.

21. The method of claim 18, wherein emulating by the primary device the graphical representation of the application running in the secondary device based on the information of the event comprising:
identifying a user of the secondary device based on an identity management system;
authorizing a level of access to the graphical representation of the application running in the secondary device to a user of the primary device based on the identity of the user of the secondary device; and
emulating on the primary device at least one portion of the graphical representation of the application running in the secondary device based on the access level of the user of the primary device.

22. The method of claim 21, wherein the identity management system stores a relationship of each of the secondary device with corresponding user to dynamically determine the identity of the user of the at least one secondary device, wherein the identity management system dynamically update the relationship when a user of the at least one secondary device is changed.

23. The method of claim 21, wherein the relationship is setup by the identity management system to deliver the information of the event associated with the application running in the secondary device to the primary device using a brokering agent, wherein the brokering agent determines the at least one portion of the graphical representation of the application running in the at least one secondary device to be emulated on the primary device.

24. The method of claim 18, wherein a time unit at which the information of the event received at the primary device is different than a time unit at which the event is generated in the at least one secondary device.

25. The method of claim 18, wherein the graphical representation displays a state of the application running in the at least one secondary device, wherein the state of the application is dynamically determined based on the information of the event associated with the application running in the at least one secondary device, wherein a time unit at which the state of the application running in the at least secondary device on the primary device is different than a time unit at which the state of application changes in the at least one secondary device.

26. The method of claim 18, wherein the secondary device is one of a wearable device and an Internet of Things (IoT) device.

27. The method of claim 18, wherein the secondary device does not comprises at least one of a display screen and a user interface.

28. The method of claim 18, wherein the application, running in the secondary device, does not comprises a user interface.

29. A method for emulating an application running in a at least one secondary device on an primary device, the method comprising:
receiving, by the primary device, information about a graphical representation of an application running in the at least one secondary device;
emulating, by the primary device, the graphical representation of the application running in the at least one secondary device; and
displaying, by the primary device, the graphical representation of the application running in the at least one secondary device, wherein a time unit at which the graphical representation of the application running in the at least secondary device displayed on the primary device is different than a time unit at which the at least one secondary device displays the graphical representation.

30. The method of claim 29, wherein the difference caused due to at least one of a periodic interval and a time taken to wait for the information to be received from a series of secondary devices.

31. The method of claim 29, wherein emulating by the primary device the graphical representation of the application running in the at least one secondary device comprising:
identifying a user of the secondary device based on an identity management system, wherein the information of the event associated with the application running in the primary device corresponds to the user of the secondary device;
authorizing an level of access to the graphical representation of the of the application running in the secondary device to a user of the primary device based on the identity of the user of the primary device; and
emulating the graphical representation of the application running in the secondary device on the primary device based on the access level of the user of the primary device.

32. The method of claim 31, wherein the identity management system stores a relationship of each of the secondary device with corresponding user to dynamically determine the identity of the user of the at least one secondary device, wherein the identity management system dynamically update the relationship when a user of the at least one secondary device is changed.

33. The method of claim 31, wherein the relationship is setup by the identity management system to deliver the information of the event associated with the application running in the secondary device to the primary device using a brokering agent, wherein the brokering agent determines the at least one portion of the graphical representation of the application running in the at least one secondary device to be emulated on the primary device.

34. The method of claim 29, wherein the graphical representation displays a state of the application running in the at least one secondary device, wherein the state of the application is dynamically determined based on the information of the event associated with the application running in the at least one secondary device, wherein a time unit at which the state of the application running in the at least secondary device on the primary device is different than a time unit at which the state of application changes in the at least one secondary device.

35. A system comprising:
a secondary device configured to:
detect an event associated with the application running in the secondary device,
display a graphical representation of the application running in the secondary device based on the event, and
send information about the graphical representation; and
a primary device configured to:
receive the information about the graphical representation,
emulate the graphical representation of the application running in the secondary device, and
display the graphical representation of the application running in the secondary device.

36. The system of claim 35, wherein a time unit at which the graphical representation of the application running in the at least secondary device displayed on the primary device is different than a time unit at which the at least one secondary device displays the graphical representation.

37. The device of claim 37, wherein the difference is caused due to at least one of a periodic interval and a time taken to wait for the information to be received from a series of the secondary devices.

38. The system of claim 35, wherein emulate the graphical representation of the application running in the secondary device based on the information of the event comprising:
identify a user of the secondary device based on an identity management system, wherein the information of the event associated with the application running in the electronic device corresponds to the user of the secondary device;
authorize an level of access to the graphical representation of the of the application running in the secondary device to a user of the primary device based on the identity of the user of the electronic device; and
emulate the graphical representation of the application running in the secondary device on the by the primary device based on the access level of the user of the primary device.

39. The system of claim 38, wherein the identity management system is configured to store a relationship of each of the secondary device with corresponding user to dynamically determine the identity of the user of the at least one secondary device, wherein the identity management system is configured to dynamically update the relationship when a user of the at least one secondary device is changed.

40. The system of claim 39, wherein the relationship is setup by the identity management system to deliver the information of the event associated with the application running in the secondary device to the primary device using a brokering agent, wherein the brokering agent is configured to determine the at least one portion of the graphical representation of the application running in the at least one secondary device to be emulated on the primary device.

41. The system of claim 35, wherein a time unit at which the information of the event received at the primary device is different than a time unit at which the event is generated in the at least one secondary device.

42. The system of claim 35, wherein the graphical representation displays a state of the application running in the at least one secondary device, wherein the state of the application is dynamically determined based on the information of the event associated with the application running in the at least one secondary device, wherein a time unit at which the state of the application running in the at least secondary device on the primary device is different than a time unit at which the state of application changes in the at least one secondary device.
